(19) United States
(12) Patent Application Publication
(10) Pub. No.: US 2024/0242089 A1
(43) Pub. Date: Jul. 18, 2024

(54) DATA PROTECTION METHOD, TRAINING METHOD AND APPARATUS FOR NETWORK STRUCTURE, MEDIUM, AND DEVICE

(71) Applicant: Lemon Inc., Grand Cayman (KY)

(72) Inventors: Jiankai SUN, Los Angeles, CA (US); Weihao GAO, Beijing (CN); Junyuan XIE, Beijing (CN); Chong WANG, Los Angeles, CA (US)

(21) Appl. No.: 18/565,015

(22) PCT Filed: Apr. 28, 2022
(86) PCT No.: PCT/SG2022/050261

§ 371 Date: Nov. 28, 2023

(30) Foreign Application Priority Data
May 28, 2021 (CN) 202110593862.X

(51) Int. Cl. G06N 3/098; G06N 3/04

(52) U.S. Cl. CPC G06N 3/098; G06N 3/04

(57) ABSTRACT

The present disclosure relates to a data protection method, a training method and apparatus for a network structure, a medium, and a device. The data protection method includes: obtaining original feature information of a target batch of reference samples for a passive party of a joint training model; and processing the original feature information by means of a target feature processing network structure to obtain target feature information corresponding to the original feature information. A neural network structure is trained by at least aiming at minimizing a coupling degree of between original training feature information and target training feature information of training samples for the passive party to obtain the target feature processing network structure. The target training feature information is feature information corresponding to the original training feature information that is outputted from the neural network structure using the original training feature information as an input.

### CROSS-REFERENCE TO RELATED APPLICATION

The present application claims a priority to the Chinese Patent Application No. 202110593862.X filed on May 28, 2021 and entitled “DATA PROTECTION METHOD, TRAINING METHOD AND APPARATUS FOR NETWORK STRUCTURE, MEDIUM, AND DEVICE”, the entire content of which is incorporated herein by reference.

### FIELD

The present disclosure relates to the field of computer technologies, and more particularly, to a data protection method and apparatus, a training method and apparatus for a network structure, a medium, and a device.

### BACKGROUND

With the development of artificial intelligence technology, machine learning has been increasingly widely used. In recent years, in order to protect data security and solve a problem of data silos, a joint training model is typically used in the related art to implement joint training of a machine learning model without exposing original data. For a supervised machine learning model, a party with sample label data is usually referred to as an active party, and a party without the sample label data is referred to as a passive party. Data transmitted mutually between the active and passive parties is important data needing to be protected.

### SUMMARY

This summary is provided to briefly introduce concepts to be described in detail in the following description of embodiments. However, this summary is neither intended to identify key or essential features of the claimed technical solutions, nor intended to limit the scope of the claimed technical solutions.

According to a first aspect of the present disclosure, a data protection method is provided. The method includes: obtaining original feature information of a target batch of reference samples for a passive party of a joint training model; and processing the original feature information by means of a target feature processing network structure to obtain target feature information corresponding to the original feature information. A neural network structure is trained by at least aiming at minimizing a coupling degree between original training feature information and target training feature information of training samples for the passive party to obtain the target feature processing network structure. The target training feature information is feature information corresponding to the original training feature information that is outputted from the neural network structure using the original training feature information as an input of the neural network structure.

According to a second aspect of the present disclosure, a training method for a feature processing network structure is provided. The method includes: obtaining original training feature information of a specified batch of training samples for a passive party of a joint training model and target training feature information outputted by a neural network structure through processing the original training feature information; obtaining target gradient information corresponding to a parameter of the neural network structure, wherein the target gradient information is determined according to a predetermined loss function and the target training feature information, and the predetermined loss function includes a loss function characterizing a coupling degree between the original training feature information and the target training feature information; updating the parameter of the neural network structure based on the target gradient information, wherein the neural network structure is trained by at least aiming at minimizing the coupling degree between the original training feature information and the target training feature information; determining whether training of the neural network structure is completed; and obtaining a target feature processing network structure in response to completion of the training of the neural network structure.

According to a third aspect of the present disclosure, a data protection apparatus is provided. The apparatus includes: an original feature information obtaining module configured to obtain original feature information of a target batch of reference samples for a passive party of a joint training model; and a target feature information determination module configured to process the original feature information by means of a target feature processing network structure to obtain target feature information corresponding to the original feature information. A neural network structure is trained by at least aiming at minimizing a coupling degree between original training feature information and target training feature information of training samples for the passive party to obtain the target feature processing network structure, and the target training feature information is feature information corresponding to the original training feature information that is outputted from the neural network structure using the original training feature information as an input of the neural network structure.

According to a fourth aspect of the present disclosure, a training apparatus for a feature processing network structure is provided. The apparatus includes: a training feature information obtaining module configured to obtain original training feature information of a specified batch of training samples for a passive party of a joint training model and target training feature information outputted by a neural network structure through processing the original training feature information; a target gradient information obtaining module configured to obtain target gradient information corresponding to a parameter of the neural network structure, wherein the target gradient information is determined according to a predetermined loss function and the target training feature information, and the predetermined loss function includes a loss function characterizing a coupling degree between the original training feature information and the target training feature information; a parameter updating module configured to update the parameter of the neural network structure based on the target gradient information, wherein the neural network structure is trained by at least aiming at minimizing the coupling degree between the original training feature information and the target training feature information; a determination module configured to determine whether training of the neural network structure is completed; and a network structure obtaining module configured to obtain a target feature processing network structure in response to completion of the training of the neural network structure.

According to a fifth aspect of the present disclosure, a computer-readable medium is provided. The computer-readable medium has a computer program stored thereon. The computer program, when executed by a processor, implements steps of the method according to the first aspect of the present disclosure.

According to a sixth aspect of the present disclosure, a computer-readable medium is provided. The computer-readable medium has a computer program stored thereon. The computer program, when executed by a processor, implements steps of the method according to the second aspect of the present disclosure.

According to a seventh aspect of the present disclosure, an electronic device is provided. The electronic device includes: a memory storing a computer program thereon; and a processor configured to execute the computer program in the memory to implement steps of the method according to the first aspect of the present disclosure.

According to an eighth aspect of the present disclosure, an electronic device is provided. The electronic device includes: a memory storing a computer program thereon; and a processor configured to execute the computer program in the memory to implement steps of the method according to the second aspect of the present disclosure.

Other features and advantages of the present disclosure will be described in detail in the subsequent specific implementations.

### BRIEF DESCRIPTION OF THE DRAWINGS

The above and other features, advantages, and aspects of the embodiments of the present disclosure will become more apparent in conjunction with the accompanying drawings and with reference to the following specific implementations. Throughout the drawings, the same or similar reference numerals indicate the same or similar elements. It should be understood that the drawings are schematic, and the components and elements are not necessarily drawn to scale, in which:

FIG. 1 is a schematic diagram of an implementation environment according to an exemplary embodiment.

FIG. 2 is a flowchart of a data protection method according to an exemplary embodiment.

FIG. 3 is a flowchart of a training method for a feature processing network structure according to an exemplary embodiment.

FIG. 4 is a schematic diagram of training a neural network structure according to an exemplary embodiment.

FIG. 5 is a block diagram of a data protection apparatus according to an exemplary embodiment.

FIG. 6 is a block diagram of a training apparatus for a feature processing network structure according to an exemplary embodiment.

FIG. 7 is a schematic structural diagram of an electronic device according to an exemplary embodiment.

### DESCRIPTION OF EMBODIMENTS

Embodiments of the present disclosure will be described in detail below with reference to the accompanying drawings. While some embodiments of the present disclosure are illustrated in the drawings, it should be understood that the present disclosure may be embodied in various forms and should not be construed as being limited to the embodiments set forth herein. Instead, these embodiments are provided for a complete and thorough understanding of the present disclosure. It should be understood that the drawings and the embodiments of the present disclosure are for illustration purposes only and are not intended to limit the scope of the present disclosure.

It should be understood that respective steps recited in embodiments of the method of the present disclosure may be performed in a different order, and/or performed in parallel. Moreover, the embodiments of the method may include additional steps and/or omit performing the illustrated steps. The scope of the present disclosure is not limited in this respect.

The term “including” and variations thereof as used herein are open-ended, i.e., “including, but not limited to”. The term “based on” means “based at least in part on”. The term “one embodiment” means “at least one embodiment”; the term “another embodiment” means “at least one additional embodiment”; and the term “some embodiments” means “at least some embodiments”. Relevant definitions for other terms will be given in the following description.

It should be noted that concepts such as “first” and “second” mentioned in the present disclosure are only used to distinguish apparatuses, modules, or units, and are neither used to limit that these apparatuses, modules, or units are definitely different apparatuses, modules or units, nor used to limit a sequence or interdependence of functions performed by these apparatuses, modules, or units.

It should be noted that terms “a”, “an”, or “plurality of” in the present disclosure are illustrative rather than limiting, which shall be construed as “one or more” by those skilled in the art, unless clearly indicated otherwise.

The names of messages or information exchanged between apparatuses in the embodiments of the present disclosure are for illustrative purposes only, and are not intended to limit the scope of the messages or information.

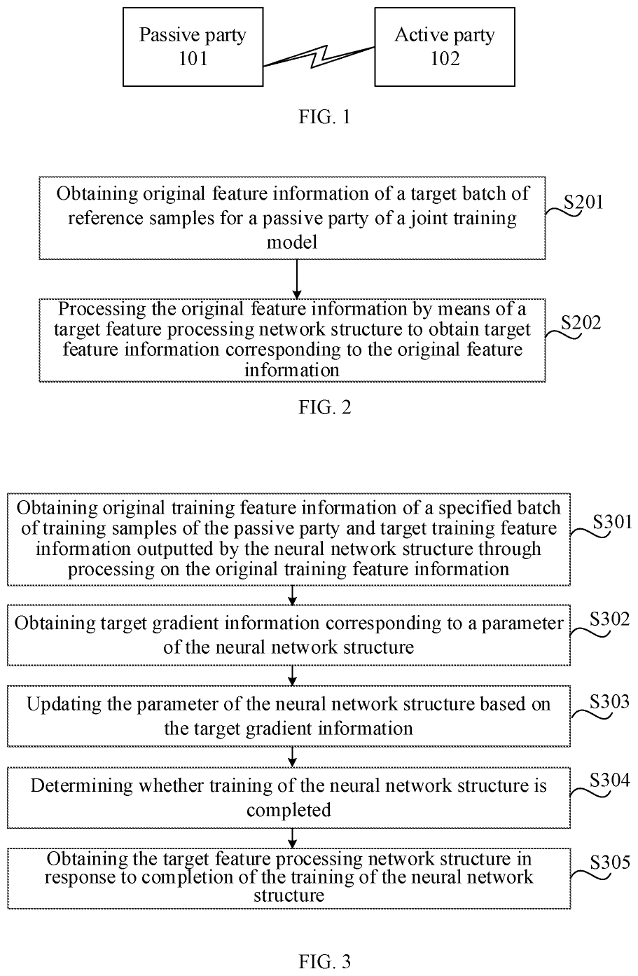

An application scenario of the present disclosure is introduced first. The present disclosure may be applied in a federated learning process or joint learning process. A joint training model is typically used to complete joint training of a machine learning model without exposing original data. For a supervised machine learning model, a party with sample label data is usually referred to as an active party, and a party without the sample label data is referred to as a passive party. The active party and the passive party may interact with each other through a network to receive or transmit a message, etc. Data mutually transmitted between the active and passive parties is important data needing to be protected. FIG. 1 is a schematic diagram of an implementation environment according to an exemplary embodiment. As illustrated in FIG. 1, the implementation environment may include a passive party 101 and an active party 102. Communication coupling may be performed between the passive party 101 and the active party 102. For example, communication may be performed using any one of 3rd Generation (3G), 4G, 5G, Narrow Band-Internet of Things (NB-IOT), enhanced Machine-Type Communication (eMTC), Long Term Evolution (LTE), and LTE-Advanced (LTE-A), etc.

It should be noted that, in the present disclosure, when reference is made to the passive party performing operations of transmitting, receiving, and processing data, it can be understood that the passive party performs these operations through a server device of the passive party. Moreover, when reference is made to the active party performing operations of transmitting, receiving, and processing data, it can be understood that the active party performs these operations through a server device of the active party.

The following describes the technical solutions in detail according to the embodiments of the present disclosure.

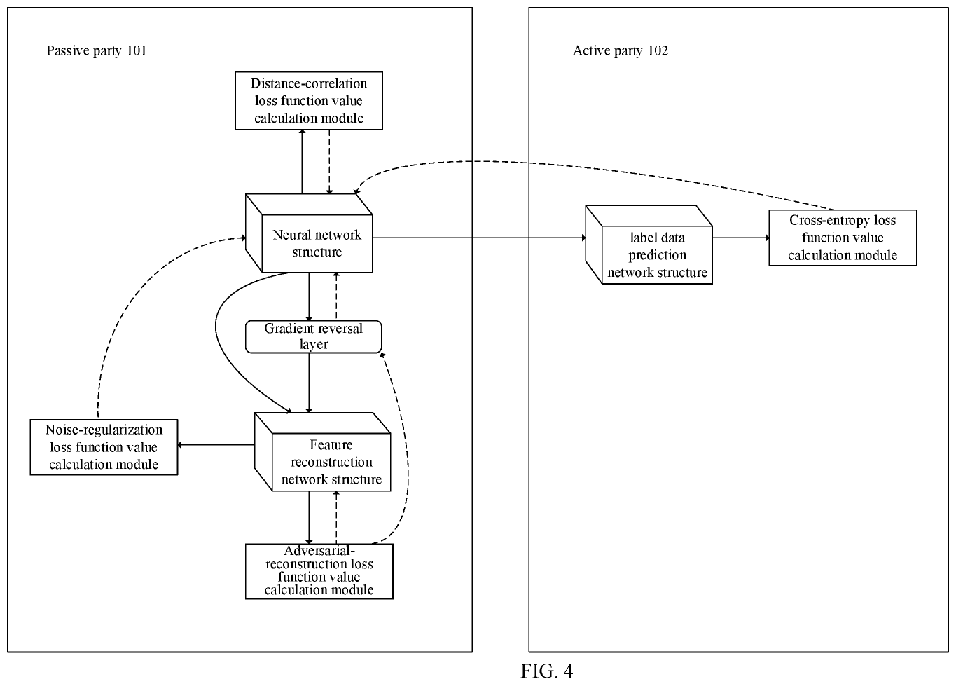

FIG. 2 is a flowchart of a data protection method according to an exemplary embodiment. The method may be applied in a passive party of the joint training model, like the passive party 101 as illustrated in FIG. 1. As illustrated in FIG. 2, the method may include operations at block S201 and block S202.

In block S201, original feature information of a target batch of reference samples for a passive party of a joint training model is obtained.

Here, the joint training model is usually trained by inputting a batch of samples into an initial model every time. The target batch of reference samples is a batch of samples in one training process. The passive party may select a batch of samples from a sample set as the target batch of the reference samples. The original feature information of the target batch of the reference samples may include a set of respective original feature information of all reference samples in the target batch.

In block S202, the original feature information is processed by means of a target feature processing network structure to obtain target feature information corresponding to the original feature information.

The target feature processing network structure may be a multi-layer neural network structure. After the original feature information of the target batch of the reference samples is obtained, the original feature information may be inputted into the target feature processing network structure to obtain the target feature information corresponding to the original feature information outputted from the target feature processing network structure. The target feature information is feature embedding obtained by processing the original feature information of the reference samples for the passive party.

The passive party may transmit the target feature information to the active party. The active party has real sample label data, and may perform label prediction based on the target feature information, thereby calculating label prediction loss and gradient-related information. Therefore, the target feature information transmitted by the passive party to the active party is data needing key protection. The target feature information is obtained by processing the original feature information. When the original feature information of the passive party may be reversely deduced based on the target feature information after the target feature information is received by the active party, a risk of leakage of original data of the passive party occurs, thereby lowering data security in the joint learning process.

In the present disclosure, a neural network structure is trained by at least aiming at minimizing a coupling degree between original training feature information and target training feature information of training samples for the passive party to obtain the target feature processing network structure. The target training feature information is feature information corresponding to the original training feature information that is outputted from the neural network structure using the original training feature information as an input of the neural network structure.

Here, the target feature processing network structure may be pre-trained. The training samples of the passive party may be samples used in a process of obtaining the target feature processing network by training. The target batch of the reference samples may be samples used in a process of training the joint training model after training of the target feature processing network structure is completed. The training samples may be the same as or differ from the reference samples.

The higher the coupling degree between the original training feature information and the target training feature information, the greater a correlation between the original training feature information and the target training feature information, and the greater a possibility that the original training feature information can be reversely deduced from the target training feature information. Otherwise, the lower the coupling degree between the original training feature information and the target training feature information, the smaller the correlation between the original training feature information and the target training feature information, and the smaller the possibility that the original training feature information can be reversely deduced from the target training feature information.

The neural network structure is trained by at least aiming at minimizing the coupling degree between the original training feature information and the target training feature information of the training samples for the passive party to obtain the target feature processing network structure. Therefore, that the original feature information of the target batch of the reference samples is processed by means of the trained target feature processing network to obtain the target feature information may enable a coupling degree between the target feature information and the original feature information to be reduced and lower a possibility that the original feature information can be reversely deduced from the target feature information, thereby reducing the risk of the leakage of the original data of the passive party.

According to the above technical solutions, the original feature information of the target batch of the reference samples for the passive party of the joint training model is obtained. The original feature information is processed by means of the target feature processing network structure to obtain the corresponding target feature information. The neural network structure is trained by at least aiming at minimizing the coupling degree between the original training feature information and the target training feature information of the training samples for the passive party to obtain the target feature processing network structure. As such, the original feature information of the target batch of the reference samples is processed by means of the trained target feature processing network structure to obtain the target feature information, which may enable the coupling degree between the target feature information and the original feature information to be reduced and lowers the possibility that the original feature information can be reversely deduced from the target feature information, thereby reducing the risk of the leakage of the original data of the passive party, achieving protection for the original data of the passive party and enhancing data security.

A process of obtaining the target feature processing network structure by training the neural network structure will be given in the following description. FIG. 3 is a flowchart of a training method for a feature processing network structure according to an exemplary embodiment. As illustrated in FIG. 3, the method may include operations at block S301 to block S305.

In block S301, original training feature information of a specified batch of training samples for the passive party of the joint training model and target training feature information outputted by the neural network structure through processing on the original training feature information are obtained.

Here, the neural network structure may also be trained by inputting a batch of samples into the neural network structure every time. The specified batch of training samples may be a batch of samples in one training process of the neural network structure.

In block S302, target gradient information corresponding to a parameter of the neural network structure is obtained.

Here, the target gradient information is determined based on a predetermined loss function and the target training feature information. The predetermined loss function may include a loss function characterizing a coupling degree between the original training feature information and the target training feature information.

In block S303, the parameter of the neural network structure is updated based on the target gradient information.

In block S304, it is determined whether training of the neural network structure is completed.

Exemplarily, the parameter of the neural network structure may be updated by using a gradient descent method. In this way, the coupling degree between the original training feature information and the target training feature information may gradually decrease during training. For example, when a function value of the predetermined loss function is minimum, it may be determined that the training of the neural network structure is completed, thereby achieving a purpose of training the neural network structure by at least aiming at minimizing the coupling degree between the original training feature information and the target training feature information.

In block S305, the target feature processing network structure is obtained in response to completion of the training of the neural network structure.

When it is determined that the training of the neural network structure is not completed, the next batch of training samples may continue to be obtained to train the neural network structure until the training of the neural network structure is completed to obtain the target feature processing network structure.

According to the above technical solutions, the target gradient information corresponding to the parameter of the neural network structure is determined based on the predetermined loss function and the target training feature information. The predetermined loss function may include the loss function characterizing the coupling degree between the original training feature information and the target training feature information. The parameter of the neural network structure is updated based on the target gradient information, and the target feature processing network structure is obtained in response to the completion of the training of the neural network structure. As such, through the trained target feature processing network structure, a coupling degree between the target feature information obtained by processing the original feature information of the passive party and the original feature information is reduced, which lowers the possibility that the original feature information may be reversely deduced from the target feature information, protects the original data of the passive party, and improves the data security.

A process of training the neural network structure in the present disclosure is described below in combination with FIG. 4. FIG. 4 is a schematic diagram of training a neural network structure according to an exemplary embodiment. In FIG. 4, a solid arrow represents forward propagation, and a dashed arrow represents backward propagation.

In the present disclosure, the target gradient information includes at least one of distance correlation gradient information, adversarial reconstruction gradient information, and noise regularization gradient information. The predetermined loss function correspondingly includes at least one of a distance correlation loss function, an adversarial reconstruction loss function, and a noise regularization loss function.

Block S302 of obtaining the target gradient information corresponding to the parameter of the neural network structure correspondingly may include at least one of blocks (a), (b), and (c).

In block (a), the distance correlation gradient information is determined according to the original training feature information, the target training feature information, and the distance correlation loss function.

The distance correlation loss function is a function characterizing a distance correlation between the original training feature information and the target training feature information. The smaller the distance correlation between the original training feature information and the target training feature information, the lower the coupling degree between the original training feature information and the target training feature information. The greater the distance correlation between the original training feature information and the target training feature information, the higher the coupling degree between the original training feature information and the target training feature information. The distance correlation loss function may be expressed as (1) below:

$$L d = D C O R ( X , F ( X ) ) \qquad ( 1 )$$

where Ld represents the distance correlation loss function, X represents the original training feature information, and F(X) represents the target training feature information.

As illustrated in FIG. 4, at the passive party, the target training feature information may be transmitted by the neural network structure to a distance-correlation loss function value calculation module through forward propagation. The distance-correlation loss function value calculation module may be configured to calculate a function value of the distance correlation loss function based on the original training feature information, the target training feature information, and the distance correlation loss function. The passive party may determine the distance correlation gradient information based on the function value and return the distance correlation gradient information to the neural network structure through backward propagation. For how to calculate the distance correlation gradient information, reference can be made to the related art. In this way, the neural network structure may update its parameter by using the gradient descent method based on the distance correlation gradient information, so that the distance correlation between the original training feature information and the target training feature information decreases progressively, i.e., the coupling degree between the original training feature information and the target training feature information becomes lower and lower.

In block (b), first gradient information corresponding to the parameter of the neural network structure is determined according to the original training feature information, first prediction feature information, and the adversarial reconstruction loss function, and gradient information obtained from processing of the first gradient information by a gradient reversal layer is determined as the adversarial reconstruction gradient information.

Here, the first prediction feature information is obtained by reconstructing based on the target training feature information. As illustrated in FIG. 4, in an example, the neural network structure may transmit the target training feature information to the feature reconstruction network structure, and the feature reconstruction network structure may be used to reconstruct the target training feature information, i.e., predict the original training feature information on the basis of the target training feature information. The first prediction feature information may be feature information outputted from a feature reconstruction network structure obtained by inputting the target training feature information into the feature reconstruction network structure.

The feature reconstruction network structure may transmit the first prediction feature information to an adversarial-reconstruction loss function value calculation module by means of forward propagation. The adversarial-reconstruction loss function value calculation module may calculate a function value of the adversarial reconstruction loss function based on the original training feature information, the first prediction feature information, and the adversarial reconstruction loss function. The passive party may determine the first gradient information corresponding to the parameter of the neural network structure according to the function value. The adversarial reconstruction loss function is a function characterizing a distance between the first prediction feature information and the original training feature information, and the distance may be, for example, a Euclidean distance. The smaller the distance between the first prediction feature information and the original training feature information, the greater a similarity between the first prediction feature information and the original training feature information, i.e., the more similar the original training feature information predicted by the feature reconstruction network structure is to actual original training feature information, the higher the coupling degree between the target training feature information and the original training feature information. Otherwise, the greater the distance between the first prediction feature information and the original training feature information, the smaller the similarity between the first prediction feature information and the original training feature information, i.e., the greater a difference between the original training feature information predicted by the feature reconstruction network structure and the actual original training feature information, the lower the coupling degree between the target training feature information and the original training feature information. The adversarial reconstruction loss function may be expressed as (2) below:

$$Lr = P ( X , R 1 ( F ( X ) ) ) \qquad ( 2 )$$

where Lr represents the adversarial reconstruction loss function, X represents the original training feature information, R1(F(X)) represents the first prediction feature information, and P represents the function characterizing the distance between the first prediction feature information and the original training feature information, which for example may be a Euclidean distance calculation function.

As illustrated in FIG. 4, a gradient reversal layer (GRL) is disposed between the neural network structure and the feature reconstruction network structure. During backward propagation, the passive party may determine the gradient information obtained from the processing of the first gradient information by the GRL as the adversarial reconstruction gradient information and return the adversarial reconstruction gradient information to the neural network structure. For example, the GRL may multiply the first gradient information by −λ, and the passive party may determine the gradient information obtained by multiplying the first gradient information by −λ as the adversarial reconstruction gradient information, where λ is a number greater than 0 and has a value that may be predetermined.

Here, the adversarial reconstruction loss function characterizes a distance between the first prediction feature information and the original training feature information, in such a manner that the smaller the adversarial reconstruction loss function, i.e., the greater the similarity between the first prediction feature information and the original training feature information, indicating that the more similar the original training feature information predicted by the feature reconstruction network structure is to the actual original training feature information (meaning that the actual original training feature information may be easily reversely deduced from the target training feature information), the greater the coupling degree between the target training feature information and the original training feature information. The purpose of training the neural network structure is to reduce the coupling degree between the target training feature information and the original training feature information. Therefore, when the gradient information is returned to the neural network structure, the neural network structure may update the parameter thereof by using the gradient descent method through the processing of the GRL based on the adversarial reconstruction gradient information. The aim of training the neural network structure is actually to gradually increase the function value of the adversarial reconstruction loss function to achieve a purpose of increasing the difficulty of reversely deducing the actual original training feature information from the target training feature information as much as possible, thereby gradually lowering the coupling degree between the target training feature information and the original training feature information.

It should also be noted that, during forward propagation, when the target feature information is transmitted to the feature reconstruction network structure after passing through the GRL, the GRL does not perform any processing on the target feature information but directly transmits the target feature information to the feature reconstruction network structure.

In block (c), the noise regularization gradient information is determined according to second prediction feature information, noise information, and the noise regularization loss function.

Here, the second prediction feature information is obtained through reconstruction based on the target training feature information. The first prediction feature information is the same as or different from the second prediction feature information. In an example, as illustrated in FIG. 4, the feature reconstruction network structure may transmit the outputted first prediction feature information to a noise-regularization loss function value calculation module, and the first prediction feature information may be used as second prediction gradient information for determining the noise regularization gradient information, i.e., the first prediction feature information is the same as the second prediction feature information. In another example, the second prediction feature information may also be obtained by reconstruction of other reconstruction modules in the passive party based on the target training feature information and differ from the first prediction feature information. A transmission manner illustrated in FIG. 4 is merely exemplary and does not limit the implementations of the present disclosure.

The noise information may be random noise information, such as random Gaussian noise information. The noise regularization loss function may be a function characterizing an error between the second prediction feature information and the noise information. The smaller the error between the second prediction feature information and the noise information, the more the original training feature information reconstructed from the target training feature information resembles the noise information, i.e., the lower the coupling degree between the target training feature information and the original training feature information. For example, the noise regularization loss function may be expressed as (3) below:

$${L}_{n} = P {R}_{2} ( F ( X ) ) - {X}_{n o i s e} {P}_{2}^{2} \qquad ( 3 )$$

where Ln represents the noise regularization loss function, R2(F(X)) represents the second prediction feature information, and Xnoise represents the noise information.

The noise-regularization loss function value calculation module may determine a function value of the noise regularization loss function according to the second prediction feature information, the noise information, and the noise regularization loss function. The passive party may calculate the noise regularization gradient information based on the function value and return the noise regularization gradient information to the neural network structure by means of backward propagation. The neural network structure may update its parameter by using the gradient descent method. In this way, the second prediction feature information is made closer to the noise information, i.e., the original training feature information reconstructed from the target training feature information more resembles the noise information, making the coupling degree between the target training feature information and the original training feature information gradually decrease.

It should be noted that the target gradient information corresponding to the parameter of the neural network structure may be determined by using at least one of (a), (b), and (c). In a case where more than one of the three manners is used, i.e., in a case where the target gradient information includes more than one of the distance correlation gradient information, the adversarial reconstruction gradient information, and the noise regularization gradient information, the neural network structure updates its own parameter based on the plurality of pieces of gradient information. In addition, the feature reconstruction network structure, the GRL, the distance-correlation loss function value calculation module, the adversarial-reconstruction loss function value calculation module, and the noise-regularization loss function value calculation module illustrated in FIG. 4 are only used when the neural network structure is trained. After the training of the neural network structure is completed to obtain the target feature processing network structure, these modules are not involved in an actual process of training the joint training model.

According to the above solutions, the coupling degree between the original training feature information and the target training feature information may be characterized by each of the distance correlation loss function, the adversarial reconstruction loss function, and the noise regularization loss function. The neural network structure updates its own parameter based on the at least one of the distance correlation gradient information, the adversarial reconstruction gradient information, and the noise regularization gradient information, which may realize the purpose of training the neural network structure by at least aiming at minimizing the coupling degree between the original training feature information and the target training feature information of the training samples for the passive party.

In an embodiment, in a case where the target gradient information includes the adversarial reconstruction gradient information and the predetermined loss function includes the adversarial reconstruction loss function, a training process of the target feature processing network structure further includes: determining second gradient information corresponding to a parameter of the feature reconstruction network structure based on the original training feature information, the first prediction feature information, and the adversarial reconstruction loss function; and returning the second gradient information to the feature reconstruction network structure, so as for the feature reconstruction network structure to update the parameter of the feature reconstruction network structure based on the second gradient information.

Here, the first prediction feature information and the adversarial reconstruction loss function have been described above. The adversarial reconstruction loss function is the function characterizing the distance between the first prediction feature information and the original training feature information. The second gradient information is used to update the parameter of the feature reconstruction network structure illustrated in FIG. 4, and the feature reconstruction network structure may update its own parameter by using the gradient descent method.

In this case, two pieces of gradient information may be determined based on the function value of the adversarial reconstruction loss function. One of the two pieces of gradient information is the second gradient information used for updating the parameter of the feature reconstruction network structure, i.e., enabling the first prediction feature information reconstructed by the feature reconstruction network to be closer to the actual original training feature information. The other is the adversarial reconstruction gradient information used for updating the parameter of the neural network structure, i.e., increasing the difficulty of reversely deducing the actual original training feature information from the target training feature information as much as possible. In this way, a purpose of adversarial training is achieved.

Moreover, the feature reconstruction network structure is trained, enabling a reconstruction effect of the feature reconstruction network structure to become better and better. Therefore, the purpose of training the neural network structure further includes making the predicted original training feature information less similar to the actual original training feature information after the target training feature information is reconstructed by the feature reconstruction network structure with a better reconstruction effect.

In the present disclosure, apart from the operation of training the neural network structure by at least aiming at minimizing the coupling degree between the original training feature information and the target training feature information of training samples for the passive party to obtain the target feature processing network structure, the neural network structure may be also trained by aiming at minimizing a label data prediction difference.

The target gradient information may further include cross entropy gradient information, and the predetermined loss function may further include a cross entropy loss function.

Block S302 of obtaining the target gradient information corresponding to the parameter of the neural network structure may further include: transmitting the target training feature information to an active party of the joint training model, enabling the active party to perform label data prediction based on the target training feature information, and determining the cross entropy gradient information based on a label data prediction result and the cross entropy loss function, the cross entropy loss function being a function characterizing cross entropy between the label data prediction result and real label data; and receiving the cross entropy gradient information transmitted by the active party.

As illustrated in FIG. 4, the target training feature information may be transmitted by the passive party to the active party, and the target training feature information may be inputted by the active party into a label data prediction network structure to obtain the label data prediction result outputted by the label data prediction network structure. A cross-entropy loss function value calculation module may determine a function value of the cross entropy loss function according to the label data prediction result and the cross entropy loss function, and the active party may calculate the cross entropy gradient information based on the function value. The cross entropy loss function is the function characterizing the cross entropy between the label data prediction result and the real label data. The cross entropy gradient information may be transmitted by the active party to the passive party. The neural network structure of the passive party may use the gradient descent method to update its own parameter on the basis of the cross entropy gradient information.

In this way, not only the requirement of protecting the original data of the passive party is considered, but also a problem of precision of the joint training model is taken into account. In addition, the neural network structure may also update its own parameter based on the cross entropy gradient information to ensure accuracy of label prediction by the active party based on the target training feature information outputted by the neural network structure, thereby ensuring the precision of the joint training model.

In the present disclosure, block S304 of determining whether the training of the neural network structure is completed may include: determining that the training of the neural network structure is completed in response to that a sum of a function value of the cross entropy loss function and a product of a target function value and a corresponding weight is minimum. The target function value includes at least one of a function value of the distance correlation loss function, a function value of the adversarial reconstruction loss function, and a function value of the noise regularization loss function.

Exemplarily, taking the predetermined loss function including the distance correlation loss function, the adversarial reconstruction loss function, and the noise regularization loss function concurrently as an example, it may be determined that the training of the neural network structure is completed in response to determining that L is minimum. Here, L=L_{c}+α_{d}L_{d}+αₙLₙ+αᵣLᵣ. Lc represents the function value of the cross entropy loss function, α_{d} represents a weight corresponding to the function value of the distance correlation loss function, αₙ represents a weight corresponding to the function value of the noise regularization loss function, αᵣ represents a weight corresponding to the function value of the adversarial reconstruction loss function, and a value of each weight may be predetermined. It should be noted that this example is merely illustrative and does not limit the implementations of the present disclosure.

Here, a purpose of minimizing the function value of the cross entropy loss function is to minimize a difference between the label data prediction result and the real label data, to ensure the precision of the joint training model, to enable the product of the target function value and the corresponding weight to be minimum, and to minimize the coupling degree between the original training feature information and the target training feature information of the training sample of the passive party. In this way, it is possible to protect the original data of the passive party and ensure the precision of the joint training model.

The data protection method according to the present disclosure may further include: transmitting the target feature information to an active party of the joint training model, so as for the active party to determine gradient transmission information of a parameter of the joint training model based on the target feature information; and receiving gradient transmission information transmitted by the active party, and updating the parameter of the joint training model according to the gradient transmission information.

The gradient transmission information may be used to characterize a basis for adjusting the parameter of the joint training model transmitted by the active party to the passive party of the joint training model. As an example, the gradient transmission information may include a gradient corresponding to each neuron in an output layer of the model trained for the passive party of the joint training model by using the cross entropy loss function and corresponding to the target batch of the reference samples for the passive party.

As such, the original feature information of the target batch of the reference samples is processed through the target feature processing network structure to obtain the corresponding target feature information, which enables the coupling degree between the target feature information and the original feature information to decrease and lowers a possibility that the original feature information of the passive party may be reversely deduced by the active party from the target feature information, thereby reducing the risk of the leakage of the original data of the passive party and realizing the protection for the original data of the passive party.

The present disclosure further provides a training method for a feature processing network structure. The specific process of the training method has been described above, and a technical problem to be mainly solved by the training method is how to improve the data security. The original data of the passive party may be processed by the target feature processing network structure trained by the training method, which enables a coupling degree between the processed data and the original data to be reduced and decreases the risk of the leakage of the original data of the passive party, thereby achieving the protection for the original data of the passive party and enhancing the data security.

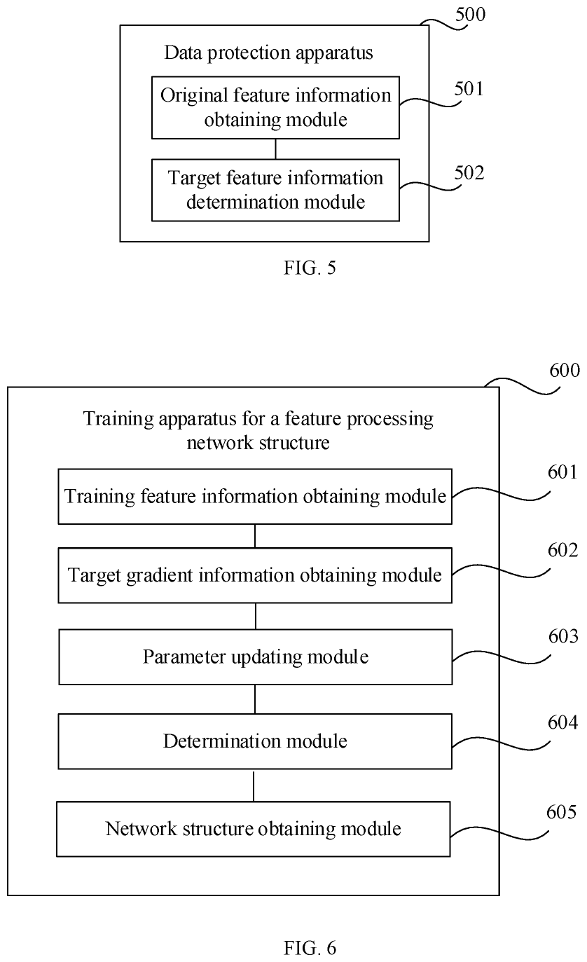

Based on the same inventive concept, the present disclosure further provides a data protection apparatus. FIG. 5 is a block diagram of a data protection apparatus according to an exemplary embodiment. As illustrated in FIG. 5, the apparatus 500 may include: an original feature information obtaining module 501 configured to obtain original feature information of a target batch of reference samples for a passive party of a joint training model; and a target feature information determination module 502 configured to process the original feature information by means of a target feature processing network structure to obtain target feature information corresponding to the original feature information. A neural network structure is trained by at least aiming at minimizing a coupling degree between original training feature information and target training feature information of training samples for the passive party to obtain the target feature processing network structure, and the target training feature information is feature information corresponding to the original training feature information that is outputted from the neural network structure using the original training feature information as an input of the neural network structure.

In an embodiment, the target feature processing network structure is obtained by training with a training apparatus for a feature processing network structure. FIG. 6 is a block diagram of a training apparatus for a feature processing network structure according to an exemplary embodiment. As illustrated in FIG. 6, the apparatus 600 may include a training feature information obtaining module 601, a target gradient information obtaining module 602, a parameter updating module 603, a determination module 604, and a network structure obtaining module 605. The training feature information obtaining module 601 is configured to obtain original training feature information of a specified batch of training samples for a passive party of a joint training model and target training feature information outputted by a neural network structure through processing the original training feature information. The target gradient information obtaining module 602 is configured to obtain target gradient information corresponding to a parameter of the neural network structure. The target gradient information is determined according to a predetermined loss function and the target training feature information, and the predetermined loss function includes a loss function characterizing a coupling degree between the original training feature information and the target training feature information. The parameter updating module 603 is configured to update the parameter of the neural network structure based on the target gradient information. The neural network structure is trained by at least aiming at minimizing the coupling degree between the original training feature information and the target training feature information. The determination module 604 is configured to determine whether training of the neural network structure is completed. The network structure obtaining module 605 is configured to obtain a target feature processing network structure in response to completion of the training of the neural network structure.

In an embodiment, the target gradient information includes at least one of distance correlation gradient information, adversarial reconstruction gradient information, and noise regularization gradient information, and the predetermined loss function correspondingly includes at least one of a distance correlation loss function, an adversarial reconstruction loss function, and a noise regularization loss function. The target gradient information obtaining module 602 correspondingly includes at least one of a distance-correlation gradient information determination module, an adversarial-reconstruction gradient information determination module, and a noise-regularization gradient information determination module. The distance-correlation gradient information determination module is configured to determine the distance correlation gradient information according to the original training feature information, the target training feature information, and the distance correlation loss function. The distance correlation loss function is a function characterizing a distance correlation between the original training feature information and the target training feature information. The adversarial-reconstruction gradient information determination module is configured to determine first gradient information corresponding to the parameter of the neural network structure according to the original training feature information, first prediction feature information, and the adversarial reconstruction loss function, and determine gradient information obtained from processing of the first gradient information by a gradient reversal layer as the adversarial reconstruction gradient information. The first prediction feature information is obtained by reconstructing based on the target training feature information, and the adversarial reconstruction loss function is a function characterizing a distance between the first prediction feature information and the original training feature information. The noise-regularization gradient information determination module is configured to determine the noise regularization gradient information according to second prediction feature information, noise information, and the noise regularization loss function. The second prediction feature information is obtained through reconstruction based on the target training feature information, the first prediction feature information is the same as or different from the second prediction feature information, and the noise regularization loss function is a function characterizing an error between the second prediction feature information and the noise information.

In an embodiment, the first prediction feature information is feature information outputted from a feature reconstruction network structure obtained by inputting the target training feature information into the feature reconstruction network structure. In a case where the target gradient information includes the adversarial reconstruction gradient information and the predetermined loss function includes the adversarial reconstruction loss function, the apparatus 600 further includes: a gradient determination module configured to determine second gradient information corresponding to a parameter of the feature reconstruction network structure based on the original training feature information, the first prediction feature information, and the adversarial reconstruction loss function; and a gradient return module configured to return the second gradient information to the feature reconstruction network structure, so as for the feature reconstruction network structure to update the parameter of the feature reconstruction network structure based on the second gradient information.

In an embodiment, the target gradient information further includes cross entropy gradient information, and the predetermined loss function further includes a cross entropy loss function. The target gradient information obtaining module 602 further includes a first transmitting module and a first receiving module. The first transmitting module is configured to transmit the target training feature information to an active party of the joint training model, enabling the active party to perform label data prediction based on the target training feature information, and determine the cross entropy gradient information based on a label data prediction result and the cross entropy loss function. The cross entropy loss function is a function characterizing cross entropy between the label data prediction result and real label data. The first receiving module is configured to receive the cross entropy gradient information transmitted by the active party.

In an embodiment, the determination module 604 is configured to determine that the training of the neural network structure is completed in response to that a sum of a function value of the cross entropy loss function and a product of a target function value and a corresponding weight is minimum. The target function value includes at least one of a function value of the distance correlation loss function, a function value of the adversarial reconstruction loss function, and a function value of the noise regularization loss function.

In an embodiment, the apparatus 500 further includes a second transmitting module and a second receiving module. The second transmitting module is configured to transmit the target feature information to an active party of the joint training model, so as for the active party to determine gradient transmission information of a parameter of the joint training model based on the target feature information. The second receiving module is configured to receive gradient transmission information transmitted by the active party, and update the parameter of the joint training model according to the gradient transmission information.

Regarding the apparatus according to any of the above embodiments, a specific manner in which each module performs operations has been described in detail in the embodiments of the method, and detailed description will be omitted here.

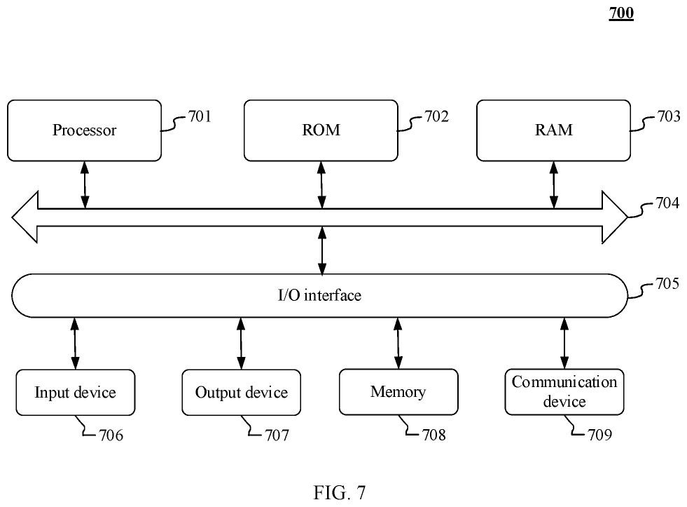

FIG. 7 is a structural schematic diagram of an electronic device 700 adapted to implement the embodiments of the present disclosure. The terminal device according to the embodiment of the present disclosure may include, but not limited to, a mobile terminal such as a mobile phone, a laptop computer, a digital broadcast receiver, a Personal Digital Assistant (PDA), a tablet computer or PAD, a Portable Multimedia Player (PMP), or a vehicle-mounted terminal (e.g., a vehicle-mounted navigation terminal), or a fixed terminal such as a digital TV, a desktop computer, etc. The electronic device illustrated in FIG. 7 is exemplary only, and should not be construed as limiting the function and scope of use of the embodiments of the present disclosure.

As illustrated in FIG. 7, the electronic device 700 may include a processor 701 (e.g., a central processing unit, a graphics processor, etc.), which may perform various appropriate actions and processes in accordance with programs stored in a ROM 702 or loaded from a memory 708 into a RAM 703. Various programs and data required for operation of the electronic device 700 may also be stored on the RAM 703. The processor 701, the ROM 702, and the RAM 703 are connected to each other through a bus 704. An input/output (I/O) interface 705 is also connected to bus 704.

Generally, the following devices may be connected to the I/O interface 705: input devices 706 including, for example, a touch screen, a touch pad, a keyboard, a mouse, a camera, a microphone, an accelerometer, a gyroscope, etc.; an output device 707 including, for example, a Liquid Crystal Display (LCD), a speaker, a vibrator, and the like; a memory 708 including, for example, magnetic tape, hard disk, etc.; and a communication device 709. The communication device 709 may allow the electronic device 700 to perform wireless or wired communication with other devices for data exchange. Although FIG. 7 illustrates the electronic device 700 having various means, it can be appreciated that it is not necessary to implement or provide all the illustrated devices. Alternatively, more or fewer devices may be implemented or provided.

In particular, according to an embodiment of the present disclosure, the processes described above with reference to the flowcharts may be implemented as computer software programs. For example, an embodiment of the present disclosure includes a computer program product, which includes a computer program carried on a computer-readable medium. The computer program includes program codes for implementing the method illustrated in any of the flowcharts. In these embodiments, the computer program may be downloaded and installed from a network through the communication device 709, or installed from the memory 708, or installed from the ROM 702. When the computer program is executed by the processor 701, the above-mentioned functions defined in the method according to the embodiments of the present disclosure are performed.

It is to be noted that the above computer-readable medium in the present disclosure may be a computer-readable signal medium or a computer-readable storage medium or any combination thereof. The computer-readable storage medium may be, but not limited to, for example, an electrical, magnetic, optical, electromagnetic, infrared, or semiconductor system, apparatus, or device, or any combination thereof. More specific examples of the computer-readable storage medium may include, but not limited to: an electrical connection having one or more wires, a portable computer disk, a hard disk, a Random Access Memory (RAM), a Read Only Memory (ROM), an Erasable Programmable Read Only Memory (EPROM) or a flash memory, an optical fiber, a Compact Disc Read-Only Memory (CD-ROM), an optical memory device, a magnetic memory device, or any suitable combination thereof. In the present disclosure, the computer-readable storage medium may be any tangible medium including or storing programs, which may be used by or used with an instruction execution system, apparatus, or device. However, in the present disclosure, the computer-readable signal medium may include a data signal propagated in a baseband or as a part of a carrier that carries computer-readable program codes. Such propagated data signal may be in various forms, including but not limited to an electromagnetic signal, an optical signal, or any suitable combination thereof. The computer-readable signal medium may be any computer-readable medium other than the computer-readable storage medium, which may transmit, propagate, or transfer programs used by or used with an instruction execution system, apparatus or device. The program codes contained on the computer-readable medium may be transmitted via any appropriate medium, including but not limited to electric cable, optical cable, Radio Frequency (RF), or any suitable combination thereof.

In some embodiments, the client and the server may communicate using any currently known or future-developed network protocol, such as HTTP (HyperText Transfer Protocol), and may be in communication interconnection with digital data in any form or medium (e.g., a communication network). Examples of communication networks include a Local Area Network (“LAN”), a Wide Area Network (“WAN”), the Internet work (e.g., the Internet), and an end-to-end network (e.g., ad hoc end-to-end network), as well as any currently known or future-developed network.

The above-mentioned computer readable medium may be contained in the above-mentioned electronic device, or it may be separated and not assembled into the electronic device.

The above-mentioned computer readable medium carries one or more programs which, when executed by the electronic device, cause the electronic device to: obtain original feature information of a target batch of reference samples for a passive party of a joint training model; and process the original feature information by means of a target feature processing network structure to obtain target feature information corresponding to the original feature information. A neural network structure is trained by at least aiming at minimizing a coupling degree between original training feature information and target training feature information of training samples for the passive party to obtain the target feature processing network structure, and the target training feature information is feature information corresponding to the original training feature information that is outputted from the neural network structure using the original training feature information as an input of the neural network structure.

Alternatively, the above-mentioned computer readable medium carries one or more programs which, when executed by the electronic device, cause the electronic device to: obtain original training feature information of a specified batch of training samples for a passive party of a joint training model and target training feature information outputted by a neural network structure through processing the original training feature information; obtain target gradient information corresponding to a parameter of the neural network structure, in which the target gradient information is determined according to a predetermined loss function and the target training feature information, and the predetermined loss function includes a loss function characterizing a coupling degree between the original training feature information and the target training feature information; update the parameter of the neural network structure based on the target gradient information, in which the neural network structure is trained by at least aiming at minimizing the coupling degree between the original training feature information and the target training feature information; determine whether training of the neural network structure is completed; and obtain a target feature processing network structure in response to completion of the training of the neural network structure.

The computer program codes for implementing the operations according to the embodiments of the present disclosure may be written in one or more programming languages or any combination thereof. The programming languages may include object-oriented programming languages, such as Java, Smalltalk, or C++, as well as conventional procedure-oriented programming languages, such as “C” language or similar programming languages. The program codes may be executed completely on a user computer, partly on the user computer, as a standalone software package, partly on the user computer and partly on a remote computer, or completely on the remote computer or server. In a case where the remote computer is involved, the remote computer may be connected to the user computer through any types of network, including a Local Area Network (LAN) or a Wide Area Network (WAN), or to an external computer (e.g., over the Internet by using an Internet service provider).

The flowcharts and block diagrams in the accompanying drawings illustrate architectures, functions, and operations of possible implementations of systems, methods, and computer program products according to various embodiments of the present disclosure. In this regard, each block in the flowcharts or block diagrams may represent a module, a program segment, or a part of codes. The module, program segment, or part of codes may contain one or more executable instructions for implementing a specified logical function. It should also be noted that, in some alternative implementations, the functions showed in blocks may occur in an order other than the order illustrated in the drawings. For example, two blocks illustrated in succession may actually be executed substantially in parallel with each other, or sometimes even in a reverse order, depending on functions involved. It should also be noted that each block in the block diagrams and/or flowcharts, or any combination of the blocks in the block diagrams and/or flowcharts, may be implemented using a dedicated hardware-based system configured to perform specified functions or operations or may be implemented using a combination of dedicated hardware and computer instructions.

The modules or units described in the embodiments of the present disclosure may be embodied as software or hardware. Here, names of the modules do not constitute a limitation on the modules the under certain circumstances. For example, the original feature information obtaining module can also be described as a “module configured to obtain information”.

The functions described herein above may be performed, at least in part, by one or more hardware logic components. For example, without limitation, exemplary types of suitable hardware logic components include a Field Programmable Gate Array (FPGA), an Application Specific Integrated Circuit (ASIC), an Application Specific Standard Product (ASSP), a System on Chip (SOC), a Complex Programmable Logic Device (CPLD), and the like.

In the context of this disclosure, a machine-readable medium may be a tangible medium, which may contain or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of a machine-readable storage medium would include an electrical connection having one or more wires, a portable computer disk, a hard disk, a Random Access Memory (RAM), a Read Only Memory (ROM), an Erasable Programmable Read Only Memory (EPROM) or flash memory, an optical fiber, a Compact Disc Read Only Memory (CD-ROM), an optical memory device, a magnetic memory device, or any suitable combination thereof.

According to one or more embodiments of the present disclosure, a data protection method is provided in example 1. The method includes: obtaining original feature information of a target batch of reference samples for a passive party of a joint training model; and processing the original feature information by means of a target feature processing network structure to obtain target feature information corresponding to the original feature information. A neural network structure is trained by at least aiming at minimizing a coupling degree between original training feature information and target training feature information of training samples for the passive party to obtain the target feature processing network structure, and the target training feature information is feature information corresponding to the original training feature information that is outputted from the neural network structure using the original training feature information as an input of the neural network structure.

According to one or more embodiments of the present disclosure, the method of example 1 is involved in example 2. The target feature processing network structure is obtained by training through: obtaining original training feature information of a specified batch of training samples for the passive party and target training feature information outputted by the neural network structure through processing on the original training feature information; obtaining target gradient information corresponding to a parameter of the neural network structure, in which the target gradient information is determined based on a predetermined loss function and the target training feature information, and the predetermined loss function includes a loss function characterizing a coupling degree between the original training feature information and the target training feature information; updating the parameter of the neural network structure based on the target gradient information; determining whether training of the neural network structure is completed; and obtaining the target feature processing network structure in response to completion of the training of the neural network structure.

According to one or more embodiments of the present disclosure, the method of example 2 is involved in example 3. The target gradient information includes at least one of distance correlation gradient information, adversarial reconstruction gradient information, and noise regularization gradient information, and the predetermined loss function correspondingly includes at least one of a distance correlation loss function, an adversarial reconstruction loss function, and a noise regularization loss function; and the operation of obtaining the target gradient information corresponding to the parameter of the neural network structure correspondingly includes at least one of: determining the distance correlation gradient information according to the original training feature information, the target training feature information, and the distance correlation loss function, in which the distance correlation loss function is a function characterizing a distance correlation between the original training feature information and the target training feature information; determining first gradient information corresponding to the parameter of the neural network structure according to the original training feature information, first prediction feature information, and the adversarial reconstruction loss function, and determining gradient information obtained from processing of the first gradient information by a gradient reversal layer as the adversarial reconstruction gradient information, in which the first prediction feature information is obtained by reconstructing based on the target training feature information, and the adversarial reconstruction loss function is a function characterizing a distance between the first prediction feature information and the original training feature information; and determining the noise regularization gradient information according to second prediction feature information, noise information, and the noise regularization loss function. The second prediction feature information is obtained through reconstruction based on the target training feature information, the first prediction feature information is the same as or different from the second prediction feature information, and the noise regularization loss function is a function characterizing an error between the second prediction feature information and the noise information.

According to one or more embodiments of the present disclosure, the method of example 3 is involved in example 4. The first prediction feature information is feature information outputted from a feature reconstruction network structure obtained by inputting the target training feature information into the feature reconstruction network structure; and in a case where the target gradient information includes the adversarial reconstruction gradient information and the predetermined loss function includes the adversarial reconstruction loss function, a training process of the target feature processing network structure further includes: determining second gradient information corresponding to a parameter of the feature reconstruction network structure based on the original training feature information, the first prediction feature information, and the adversarial reconstruction loss function; and returning the second gradient information to the feature reconstruction network structure, so as for the feature reconstruction network structure to update the parameter of the feature reconstruction network structure based on the second gradient information.

According to one or more embodiments of the present disclosure, the method of example 3 is involved in example 5. The target gradient information further includes cross entropy gradient information, and the predetermined loss function further includes a cross entropy loss function; and the operation of obtaining the target gradient information corresponding to the parameter of the neural network structure further includes: transmitting the target training feature information to an active party of the joint training model, enabling the active party to perform label data prediction based on the target training feature information, and determining the cross entropy gradient information based on a label data prediction result and the cross entropy loss function, in which the cross entropy loss function is a function characterizing cross entropy between the label data prediction result and real label data; and receiving the cross entropy gradient information transmitted by the active party.

According to one or more embodiments of the present disclosure, the method of example 5 is involved in example 6. The operation of determining whether the training of the neural network structure is completed includes: determining that the training of the neural network structure is completed in response to that a sum of a function value of the cross entropy loss function and a product of a target function value and a corresponding weight is minimum. The target function value includes at least one of a function value of the distance correlation loss function, a function value of the adversarial reconstruction loss function, and a function value of the noise regularization loss function.

According to one or more embodiments of the present disclosure, the method of example 1 is involved in example 7. The method further includes: transmitting the target feature information to an active party of the joint training model, so as for the active party to determine gradient transmission information of a parameter of the joint training model based on the target feature information; and receiving gradient transmission information transmitted by the active party, and updating the parameter of the joint training model according to the gradient transmission information.

According to one or more embodiments of the present disclosure, a training method for a feature processing network structure is provided in example 8. The method includes: obtaining original training feature information of a specified batch of training samples for the passive party of a joint training model and target training feature information outputted by the neural network structure through processing on the original training feature information; obtaining target gradient information corresponding to a parameter of the neural network structure, in which the target gradient information is determined based on a predetermined loss function and the target training feature information, and the predetermined loss function includes a loss function characterizing a coupling degree between the original training feature information and the target training feature information; updating the parameter of the neural network structure based on the target gradient information, in which a neural network structure is trained by at least aiming at minimizing a coupling degree between original training feature information and target training feature information of training samples for the passive party; determining whether training of the neural network structure is completed; and obtaining the target feature processing network structure in response to completion of the training of the neural network structure.

According to one or more embodiments of the present disclosure, the method of example 8 is involved in example 9. The target gradient information includes at least one of distance correlation gradient information, adversarial reconstruction gradient information, and noise regularization gradient information, and the predetermined loss function correspondingly includes at least one of a distance correlation loss function, an adversarial reconstruction loss function, and a noise regularization loss function. The operation of obtaining the target gradient information corresponding to the parameter of the neural network structure correspondingly includes at least one of: determining the distance correlation gradient information according to the original training feature information, the target training feature information, and the distance correlation loss function, in which the distance correlation loss function is a function characterizing a distance correlation between the original training feature information and the target training feature information; determining first gradient information corresponding to the parameter of the neural network structure according to the original training feature information, first prediction feature information, and the adversarial reconstruction loss function, and determining gradient information obtained from processing of the first gradient information by a gradient reversal layer as the adversarial reconstruction gradient information, in which the first prediction feature information is obtained by reconstructing based on the target training feature information, and the adversarial reconstruction loss function is a function characterizing a distance between the first prediction feature information and the original training feature information; and determining the noise regularization gradient information according to second prediction feature information, noise information, and the noise regularization loss function. The second prediction feature information is obtained through reconstruction based on the target training feature information, the first prediction feature information is the same as or different from the second prediction feature information, and the noise regularization loss function is a function characterizing an error between the second prediction feature information and the noise information.

According to one or more embodiments of the present disclosure, the method of example 9 is involved in example 10. The first prediction feature information is feature information outputted from a feature reconstruction network structure obtained by inputting the target training feature information into the feature reconstruction network structure. In a case where the target gradient information includes the adversarial reconstruction gradient information and the predetermined loss function includes the adversarial reconstruction loss function, the method further includes: determining second gradient information corresponding to a parameter of the feature reconstruction network structure based on the original training feature information, the first prediction feature information, and the distance correlation loss function; and returning the second gradient information to the feature reconstruction network structure, so as for the feature reconstruction network structure to update the parameter of the feature reconstruction network structure based on the second gradient information.

According to one or more embodiments of the present disclosure, the method of example 9 is involved in example 11. The target gradient information further includes cross entropy gradient information, and the predetermined loss function further includes a cross entropy loss function; and the operation of obtaining the target gradient information corresponding to the parameter of the neural network structure further includes: transmitting the target training feature information to an active party of the joint training model, enabling the active party to perform label data prediction based on the target training feature information, and determining the cross entropy gradient information based on a label data prediction result and the cross entropy loss function, in which the cross entropy loss function is a function characterizing cross entropy between the label data prediction result and real label data; and receiving the cross entropy gradient information transmitted by the active party.

According to one or more embodiments of the present disclosure, the method of example 11 is involved in example 12. The operation of determining whether the training of the neural network structure is completed includes: determining that the training of the neural network structure is completed in response to that a sum of a function value of the cross entropy loss function and a product of a target function value and a corresponding weight is minimum. The target function value includes at least one of a function value of the distance correlation loss function, a function value of the adversarial reconstruction loss function, and a function value of the noise regularization loss function.

According to one or more embodiments of the present disclosure, a data protection apparatus is provided in example 13. The apparatus includes: an original feature information obtaining module configured to obtain original feature information of a target batch of reference samples for a passive party of a joint training model; and a target feature information determination module configured to process the original feature information by means of a target feature processing network structure to obtain target feature information corresponding to the original feature information. A neural network structure is trained by at least aiming at minimizing a coupling degree between original training feature information and target training feature information of training samples for the passive party to obtain the target feature processing network structure, and the target training feature information is feature information corresponding to the original training feature information that is outputted from the neural network structure using the original training feature information as an input of the neural network structure.

According to one or more embodiments of the present disclosure, a training apparatus for a feature processing network structure is provided in example 14. The apparatus includes a training feature information obtaining module, a target gradient information obtaining module, a parameter updating module, a determination module, and a network structure obtaining module. The training feature information obtaining module is configured to obtain original training feature information of a specified batch of training samples for a passive party of a joint training model and target training feature information outputted by a neural network structure through processing the original training feature information. The target gradient information obtaining module is configured to obtain target gradient information corresponding to a parameter of the neural network structure. The target gradient information is determined according to a predetermined loss function and the target training feature information, and the predetermined loss function includes a loss function characterizing a coupling degree between the original training feature information and the target training feature information. The parameter updating module is configured to update the parameter of the neural network structure based on the target gradient information. The neural network structure is trained by at least aiming at minimizing the coupling degree between the original training feature information and the target training feature information. The determination module is configured to determine whether training of the neural network structure is completed. The network structure obtaining module is configured to obtain a target feature processing network structure in response to completion of the training of the neural network structure.

According to one or more embodiments of the present disclosure, a computer-readable medium is provided in example 15. The computer-readable medium stores a computer program thereon. The program, when executed by a processor, implements steps of the method according to any one of examples 1 to 7 or steps of the method according to any one of examples 8 to 12.

According to one or more embodiments of the present disclosure, an electronic device is provided in example 16. The electronic device includes: a memory storing a computer program thereon; and a processor configured to execute the computer program in the memory to implement steps of the method according to any one of examples 1 to 7 or steps of the method according to any one of examples 8 to 12.

The above description is only intended to explain the preferred embodiments of the present disclosure and the employed principles of the technology. It will be appreciated by those skilled in the art that the scope of the present disclosure herein is not limited to t the technical solutions formed by the specific combination of the above technical features, but should also encompass any other combinations of features described above or equivalents thereof without departing from the above concept of the present disclosure. For example, the above features and the technical features disclosed in the present disclosure having similar functions (but not limited to them) are replaced with each other to form the technical solution.

Further, although the operations are depicted in a specific order, this should not be understood as requiring these operations to be performed in the specific order illustrated or in a sequential order. Under certain circumstances, multitasking and parallel processing may be advantageous. Likewise, although several specific implementation details are included in the above discussion, these should not be construed as limitations on the scope of the present disclosure. Certain features that are described in the context of separate embodiments can also be implemented in combination in a single embodiment. Conversely, various features described in the context of a single embodiment can also be implemented in multiple embodiments separately or in any suitable combination.

Although the subject matter has been described in language specific to structural features and/or logical actions of the method, it should be understood that the subject matter defined in the appended claims is not necessarily limited to the specific features or actions described above. On the contrary, the specific features and actions described above are merely exemplary forms of implementing the claims. Regarding the apparatus according to any of the above embodiments, a specific manner in which each module performs operations has been described in detail in the embodiments of the method, and detailed description will be omitted here.

1-16. (canceled)

17. A data protection method, comprises:
obtaining original feature information of a target batch of reference samples for a passive party of a joint training model; and
processing the original feature information by means of a target feature processing network structure to obtain target feature information corresponding to the original feature information,
wherein a neural network structure is trained by at least aiming at minimizing a coupling degree between original training feature information and target training feature information of training samples for the passive party to obtain the target feature processing network structure, and the target training feature information is feature information corresponding to the original training feature information that is outputted from the neural network structure using the original training feature information as an input of the neural network structure.

18. The method according to claim 17, wherein the target feature processing network structure is obtained by training through:
obtaining original training feature information of a specified batch of training samples for the passive party and target training feature information outputted by the neural network structure through processing on the original training feature information;
obtaining target gradient information corresponding to a parameter of the neural network structure, wherein the target gradient information is determined based on a predetermined loss function and the target training feature information, and the predetermined loss function comprises a loss function characterizing a coupling degree between the original training feature information and the target training feature information;
updating the parameter of the neural network structure based on the target gradient information;
determining whether training of the neural network structure is completed; and
obtaining the target feature processing network structure in response to completion of the training of the neural network structure.

19. The method according to claim 18, wherein the target gradient information comprises at least one of distance correlation gradient information, adversarial reconstruction gradient information, and noise regularization gradient information, and the predetermined loss function correspondingly comprises at least one of a distance correlation loss function, an adversarial reconstruction loss function, and a noise regularization loss function; and
said obtaining the target gradient information corresponding to the parameter of the neural network structure correspondingly comprises at least one of:
determining the distance correlation gradient information according to the original training feature information, the target training feature information, and the distance correlation loss function, wherein the distance correlation loss function is a function characterizing a distance correlation between the original training feature information and the target training feature information;
determining first gradient information corresponding to the parameter of the neural network structure according to the original training feature information, first prediction feature information, and the adversarial reconstruction loss function, and determining gradient information obtained from processing of the first gradient information by a gradient reversal layer as the adversarial reconstruction gradient information, wherein the first prediction feature information is obtained by reconstructing based on the target training feature information, and the adversarial reconstruction loss function is a function characterizing a distance between the first prediction feature information and the original training feature information; and
determining the noise regularization gradient information according to second prediction feature information, noise information, and the noise regularization loss function, wherein the second prediction feature information is obtained through reconstruction based on the target training feature information, the first prediction feature information is the same as or different from the second prediction feature information, and the noise regularization loss function is a function characterizing an error between the second prediction feature information and the noise information.

20. The method according to claim 19, wherein the first prediction feature information is feature information outputted from a feature reconstruction network structure obtained by inputting the target training feature information into the feature reconstruction network structure; and
in a case where the target gradient information comprises the adversarial reconstruction gradient information and the predetermined loss function comprises the adversarial reconstruction loss function, a training process of the target feature processing network structure further comprises:
determining second gradient information corresponding to a parameter of the feature reconstruction network structure based on the original training feature information, the first prediction feature information, and the adversarial reconstruction loss function; and
returning the second gradient information to the feature reconstruction network structure, so as for the feature reconstruction network structure to update the parameter of the feature reconstruction network structure based on the second gradient information.

21. The method according to claim 19, wherein the target gradient information further comprises cross entropy gradient information, and the predetermined loss function further comprises a cross entropy loss function; and
said obtaining the target gradient information corresponding to the parameter of the neural network structure further comprises:
transmitting the target training feature information to an active party of the joint training model, enabling the active party to perform label data prediction based on the target training feature information, and determining the cross entropy gradient information based on a label data prediction result and the cross entropy loss function, wherein the cross entropy loss function is a function characterizing cross entropy between the label data prediction result and real label data; and
receiving the cross entropy gradient information transmitted by the active party.

22. The method according to claim 21, wherein said determining whether the training of the neural network structure is completed comprises:
determining that the training of the neural network structure is completed in response to that a sum of a function value of the cross entropy loss function and a product of a target function value and a corresponding weight is minimum, wherein the target function value comprises at least one of a function value of the distance correlation loss function, a function value of the adversarial reconstruction loss function, and a function value of the noise regularization loss function.

23. The method according to claim 17, further comprising:
transmitting the target feature information to an active party of the joint training model, so as for the active party to determine gradient transmission information of a parameter of the joint training model based on the target feature information; and
receiving gradient transmission information transmitted by the active party, and updating the parameter of the joint training model according to the gradient transmission information.

24. A training method for a feature processing network structure, comprising:
obtaining original training feature information of a specified batch of training samples for a passive party of a joint training model and target training feature information outputted by a neural network structure through processing the original training feature information;
obtaining target gradient information corresponding to a parameter of the neural network structure, wherein the target gradient information is determined according to a predetermined loss function and the target training feature information, and the predetermined loss function comprises a loss function characterizing a coupling degree between the original training feature information and the target training feature information;
updating the parameter of the neural network structure based on the target gradient information, wherein the neural network structure is trained by at least aiming at minimizing the coupling degree between the original training feature information and the target training feature information;
determining whether training of the neural network structure is completed; and
obtaining a target feature processing network structure in response to completion of the training of the neural network structure.

25. The method according to claim 24, wherein the target gradient information comprises at least one of distance correlation gradient information, adversarial reconstruction gradient information, and noise regularization gradient information, and the predetermined loss function correspondingly comprises at least one of a distance correlation loss function, an adversarial reconstruction loss function, and a noise regularization loss function; and
said obtaining the target gradient information corresponding to the parameter of the neural network structure correspondingly comprises at least one of:
determining the distance correlation gradient information according to the original training feature information, the target training feature information, and the distance correlation loss function, wherein the distance correlation loss function is a function characterizing a distance correlation between the original training feature information and the target training feature information;
determining first gradient information corresponding to the parameter of the neural network structure according to the original training feature information, first prediction feature information, and the adversarial reconstruction loss function, and determining gradient information obtained from processing of the first gradient information by a gradient reversal layer as the adversarial reconstruction gradient information, wherein the first prediction feature information is obtained by reconstructing based on the target training feature information, and the adversarial reconstruction loss function is a function characterizing a distance between the first prediction feature information and the original training feature information; and
determining the noise regularization gradient information according to second prediction feature information, noise information, and the noise regularization loss function, wherein the second prediction feature information is obtained through reconstruction based on the target training feature information, the first prediction feature information is the same as or different from the second prediction feature information, and the noise regularization loss function is a function characterizing an error between the second prediction feature information and the noise information.

26. The method according to claim 25, wherein the first prediction feature information is feature information outputted from a feature reconstruction network structure obtained by inputting the target training feature information into the feature reconstruction network structure; and
in a case where the target gradient information comprises the adversarial reconstruction gradient information and the predetermined loss function comprises the adversarial reconstruction loss function, the method further comprises:
determining second gradient information corresponding to a parameter of the feature reconstruction network structure based on the original training feature information, the first prediction feature information, and the distance correlation loss function; and
returning the second gradient information to the feature reconstruction network structure, so as for the feature reconstruction network structure to update the parameter of the feature reconstruction network structure based on the second gradient information.

27. The method according to claim 25, wherein the target gradient information further comprises cross entropy gradient information, and the predetermined loss function further comprises a cross entropy loss function; and
said obtaining the target gradient information corresponding to the parameter of the neural network structure further comprises:
transmitting the target training feature information to an active party of the joint training model, enabling the active party to perform label data prediction based on the target training feature information, and determining the cross entropy gradient information based on a label data prediction result and the cross entropy loss function, wherein the cross entropy loss function is a function characterizing cross entropy between the label data prediction result and real label data; and
receiving the cross entropy gradient information transmitted by the active party.

28. The method according to claim 27, wherein said determining whether the training of the neural network structure is completed comprises:
determining that the training of the neural network structure is completed in response to that a sum of a function value of the cross entropy loss function and a product of a target function value and a corresponding weight is minimum, wherein the target function value comprises at least one of a function value of the distance correlation loss function, a function value of the adversarial reconstruction loss function, and a function value of the noise regularization loss function.

29. A non-transitory computer-readable medium, having a computer program stored thereon, wherein the program, when executed by a processor, implements steps of the method according to claim 17.

30. A non-transitory computer-readable medium, having a computer program stored thereon, wherein the program, when executed by a processor, implements steps of the method according to claim 24.

31. An electronic device, comprising:
a memory having a computer program stored thereon; and
a processor configured to execute the computer program in the memory to implement a data protection method, comprising:
obtaining original feature information of a target batch of reference samples for a passive party of a joint training model; and
processing the original feature information by means of a target feature processing network structure to obtain target feature information corresponding to the original feature information,
wherein a neural network structure is trained by at least aiming at minimizing a coupling degree between original training feature information and target training feature information of training samples for the passive party to obtain the target feature processing network structure, and the target training feature information is feature information corresponding to the original training feature information that is outputted from the neural network structure using the original training feature information as an input of the neural network structure.

32. The electronic device according to claim 31, wherein the target feature processing network structure is obtained by training through:
obtaining original training feature information of a specified batch of training samples for the passive party and target training feature information outputted by the neural network structure through processing on the original training feature information;
obtaining target gradient information corresponding to a parameter of the neural network structure, wherein the target gradient information is determined based on a predetermined loss function and the target training feature information, and the predetermined loss function comprises a loss function characterizing a coupling degree between the original training feature information and the target training feature information;
updating the parameter of the neural network structure based on the target gradient information;
determining whether training of the neural network structure is completed; and
obtaining the target feature processing network structure in response to completion of the training of the neural network structure.

33. The electronic device according to claim 32, wherein the target gradient information comprises at least one of distance correlation gradient information, adversarial reconstruction gradient information, and noise regularization gradient information, and the predetermined loss function correspondingly comprises at least one of a distance correlation loss function, an adversarial reconstruction loss function, and a noise regularization loss function; and
said obtaining the target gradient information corresponding to the parameter of the neural network structure correspondingly comprises at least one of:
determining the distance correlation gradient information according to the original training feature information, the target training feature information, and the distance correlation loss function, wherein the distance correlation loss function is a function characterizing a distance correlation between the original training feature information and the target training feature information;
determining first gradient information corresponding to the parameter of the neural network structure according to the original training feature information, first prediction feature information, and the adversarial reconstruction loss function, and determining gradient information obtained from processing of the first gradient information by a gradient reversal layer as the adversarial reconstruction gradient information, wherein the first prediction feature information is obtained by reconstructing based on the target training feature information, and the adversarial reconstruction loss function is a function characterizing a distance between the first prediction feature information and the original training feature information; and
determining the noise regularization gradient information according to second prediction feature information, noise information, and the noise regularization loss function, wherein the second prediction feature information is obtained through reconstruction based on the target training feature information, the first prediction feature information is the same as or different from the second prediction feature information, and the noise regularization loss function is a function characterizing an error between the second prediction feature information and the noise information.

34. The electronic device according to claim 33, wherein the first prediction feature information is feature information outputted from a feature reconstruction network structure obtained by inputting the target training feature information into the feature reconstruction network structure; and
in a case where the target gradient information comprises the adversarial reconstruction gradient information and the predetermined loss function comprises the adversarial reconstruction loss function, a training process of the target feature processing network structure further comprises:
determining second gradient information corresponding to a parameter of the feature reconstruction network structure based on the original training feature information, the first prediction feature information, and the adversarial reconstruction loss function; and
returning the second gradient information to the feature reconstruction network structure, so as for the feature reconstruction network structure to update the parameter of the feature reconstruction network structure based on the second gradient information.

35. The electronic device according to claim 33, wherein the target gradient information further comprises cross entropy gradient information, and the predetermined loss function further comprises a cross entropy loss function; and
said obtaining the target gradient information corresponding to the parameter of the neural network structure further comprises:
transmitting the target training feature information to an active party of the joint training model, enabling the active party to perform label data prediction based on the target training feature information, and determining the cross entropy gradient information based on a label data prediction result and the cross entropy loss function, wherein the cross entropy loss function is a function characterizing cross entropy between the label data prediction result and real label data; and
receiving the cross entropy gradient information transmitted by the active party.

36. An electronic device, comprising:
a memory having a computer program stored thereon; and
a processor configured to execute the computer program in the memory to implement the training method for a feature processing network structure according to claim 24.
